(19) United States
(12) Patent Application Publication
(10) Pub. No.: US 2024/0196887 A1
(43) Pub. Date: Jun. 20, 2024

(54) STARCH BASED NANOPARTICLES FOR PLANT DELIVERY

(71) Applicant: MCMASTER UNIVERSITY, Hamilton (CA)

(72) Inventors: Michael J. Majcher, Hamilton (CA); Todd Hoare, Ancaster (CA)

(21) Appl. No.: 18/537,567

(22) Filed: Dec. 12, 2023

Related U.S. Application Data
(60) Provisional application No. 63/432,593, filed on Dec. 14, 2022.

(51) Int. Cl. A01N 25/26; A01N 43/84

(52) U.S. Cl. CPC A01N 25/26; A01N 43/84

(57) ABSTRACT

This specification describes the modification of starch-based nanoparticles (SNPs) by introducing one or more reactive chemical groups onto the surface of SNPs. In some examples, the SNPs are hydrophobic and have a size in the range of 10-50 nm. The SNPs may be adapted for the delivery of agrochemical agents to plants. The SNPs created herein are attractive since they are generated from a sustainable source and are generally regarded as safe (GRAS) in terms of their degradation products once they break down. In some examples, the SNPs are based on SNPs produced by existing industrial-scale production.

### RELATED APPLICATIONS

This application claims the benefit if U.S. provisional application No. 63/432,593 filed on Dec. 14, 2022, which is incorporated herein by reference.

### FIELD

This specification relates to nanoparticles, for example starch based nanoparticles, and to delivery of active agents to plants using nanoparticles.

### BACKGROUND

The following documents describe aspects of starch based nanoparticles and are incorporated herein by reference:
1. Majcher M. J., Hoare T. (2018) Advanced Hydrogel Structures. In: Jafar Mazumder M., Sheardown H., Al-Ahmed A. (eds) Functional Biopolymers. Polymers and Polymeric Composites: A Reference Series. Springer, Cham
2. Majcher M. J., Hoare T. (2018) Applications of Hydrogels. In: Jafar Mazumder M., Sheardown H., Al-Ahmed A. (eds) Functional Biopolymers. Polymers and Polymeric Composites: A Reference Series. Springer, Cham
3. Majcher M. J., Hoare T. (2018) Hydrogel Properties and Characterization Techniques. In: Jafar Mazumder M., Sheardown H., Al-Ahmed A. (eds) Functional Biopolymers. Polymers and Polymeric Composites: A Reference Series. Springer, Cham
4. Majcher M. J., Hoare T. (2018) Hydrogel Synthesis and Design. In: Jafar Mazumder M., Sheardown H., Al-Ahmed A. (eds) Functional Biopolymers. Polymers and Polymeric Composites: A Reference Series. Springer, Cham
5. Majcher, M. J., Campea, M. C., Lofts, A., and Hoare, T. R., “A Review on the Design and Fabrication of Nanoparticle Network Hydrogels (NNHs) for Biomedical, Environmental, and Industrial Applications”, Submitted to Advanced Functional Materials, Accepted on May 7, 2021 (adfm.202102355R1 and EMID:da6937010fe6d77d).
6. U.S. Pat. Nos. 6,677,386 and 9,662,824.
7. Design & Fabrication of Nanostructured Hydrogels From Biopolymer Nanoparticle Building Blocks for Biomedical and Environmental Applications, a thesis by Michael J. Majcher submitted to McMaster University, Dec. 15, 2021.

### SUMMARY

The following summary is intended to introduce the reader to the invention and detailed description but not to limit or define any claimed invention.

This specification describes nanoparticles comprising starch and an agricultural active agent, methods of making the nanoparticles, a method of treating plants with the nanoparticles and use of the nanoparticles to treat plants. Optionally, the starch may be functionalized to add hydrophobic groups. Alternatively, the starch nanoparticles may be used without functionalization to add hydrophobic groups. The nanoparticles may be applied to the plant, for example, by foliar spray.

This specification describes nanoparticles made with starch containing an agricultural active agent. The nanoparticles may have hydrophobic groups. In some examples, the starch is grafted with octenyl succinic acid and/or succinic anhydride. The nanoparticles may have a size in the range of 10-50 nm.

This specification describes a method of making a nanoparticle including providing a starch-based nanoparticle and combining an agricultural active agent with the starch-base nanoparticle. The method may also include functionalizing the starch with hydrophobic groups. In some examples, the starch is reacted with octenyl succinic acid and/or succinic anhydride.

This specification also describes a method of treating a plant comprising applying starch-based nanoparticles to the plant. In some examples, the nanoparticles are applied in a foliar spray. The nanoparticles may deliver an active agent to a plant. In some examples, the nanoparticles are hydrophobic. In some examples, the nanoparticles have a size in the range of 10-50 nm.

In some examples, the initial starch-based nanoparticles are made by reactive extrusion. Reactive extrusion removes the crystalline structure of naive starch with minimal degredation of the starch polymer chains. The resulting SNPs optionally have a very small size (10-50 nm) which is suitable for penetration into a plant leaves. The amorphous nature of the starch-based nanoparticles allows for functionalization to further chemically modify and/or crosslink the SNPs through surface functional group (i.e. hydroxyl) modification chemistries. The optional functionalization of the SNPs with hydrophobic groups (for example via grafting the starch with octenyl succinic acid (OSAn) or succinic anhydride (SAn)) in some examples (DS 0.25) increased the contact angle of sprayed watermelon and pumpkin leaves from <60° (unmodified) to ˜80°. Confocal fluorescence microscopy confirmed that the hydrophobized SNPs can both adhere to the leaf surface as well as penetrate into the leaves.

### BRIEF DESCRIPTION OF THE FIGURES

The invention or embodiments of the invention will be described further below with reference to the following figures.

FIG. 1 is a cartoon representation of a native starch nanoparticle with an exterior surface rich in hydroxyl (—OH) groups and an interior rich with crosslinked or entangled anhydrous glucose chains.

FIG. 2 shows degree of substitution of anhydride-modified SNPs: (A) Comparison of actual versus theoretical DS values for succinic anhydride-modified SNPs (SAn) functionalized at pH 10-11 (blue) and pH 8-9 (green, texture); (B) Comparison of actual versus theoretical DS values for both succinic anhydride and octyl succinic anhydride-modified SNPs functionalized at pH 8-9; the green dotted line represents 100% grafting efficiency.

FIG. 3 shows contact angle (CA) measurements for hydrophobized SNPs following drying of an SNP suspension on a leaf surface.

FIG. 4 shows photodegradation of the FITC-SNP fluorescence signal for hydrophobized SNPs tagged with either 1 mg or 2 mg of FITC isomer I (A) in natural greenhouse conditions; and (B) under simulated sunlight on benchtop.

FIG. 5 shows encapsulation efficiency of various functionalized nanoparticles.

FIG. 6 shows humic acid (HA) release from hydrophobized SNPs as measured through (A) a 3.5-5 kDa dialysis membrane and (B) a 100 kDa dialysis membrane (b).

FIG. 7 shows preliminary retention data for (A) pumpkin leaves and (B) watermelon leaves for hydrophobized FITC-SNPs.

FIG. 8 shows confocal images of transport of FITC-OSAn-0.25 starch nanoparticles following foliar spray on (A, B) the leaf surface; (C,D) the stomata; and (E,F) the root capillary. Green coloration represents the location of the SNPs (FITC filter) while red represents chloroplasts (TRITC filter).

FIG. 9 shows the chemical structures for the main additives used in this study, succinic anhydride or SAn (top) and octenyl succinic anhydride or OSAn (bottom).

FIG. 10 shows the functionalization reaction scheme for OSAn-modified starch, adapted from Sweedman et al. (2013). The same reaction would also take place with the SAn-modified starch, just without the extra alkenyl chain.

FIG. 11 shows conductometric titration data (pH and conductivity vs. volume of NaOH added) for SAn-0.10 (a), SAn-0.25 (b), OSAn-0.10 (c), and OSAn-0.25 (d).

FIG. 12 shows standard curves for (a) FITC-tagged SNPs at 1 and 2 mg FITC isomer I to 50 mg SNP showing both undialyzed (U) and dialyzed (D) SNPs to show the effect in loss of fluorescence and (b) the relative fluorescence for the tagged SNPs (all at 2 mg FITC/50 mg polymer) post-hydrophobization at comparable concentrations.

FIG. 13 shows standard curve for the starch-iodine test using 0.0125 M iodine and varying wt %'s of HA. Note that concentrations of up to 0.5 wt % were tested, but concentrations above the range of this graph did not give a linear calibration.

FIG. 14 shows schematic of the experimental protocol for the contact angle measurements to clear up any confusion with the measurements on top of the leaf surface.

FIG. 15 shows examples of the leaf sections in their 48 well plate before being quantified for their relative FITC fluorescent intensity values.

FIG. 16 shows a calibration curve run using UV-vis spectroscopy (plotting the difference in absorbances at 465 and 665 nm) for humic acid (HA).

### DETAILED DESCRIPTION

In this specification, the utility of starch-based nanoparticles to delivery an active agent to a plant was explored. Starch-based nanoparticles may have 50% or more, or 70% or more or 90% or more by weight of starch, optionally including mechanically, thermally or chemically altered forms of starch. In some examples, the nanoparticles were created by a reactive extrusion process. In particular, exemplary nanoparticles may be created by reactive extrusion methods described in U.S. Pat. Nos. 6,677,386 and 9,662,824.

In the experimental examples described herein, starch-based nanoparticles used as starting materials were made by reactive extrusion by EcoSynthetix Inc. These nanoparticles are commercially available and sold under the ECOSPHERE trademark. These and other starch-based nanoparticles are attractive as stating materials due to their optional small size (10-50 nm), generally safe degradation products, overall net neutral charge, high deformability/viscoelastic properties, stability in solution without collapsing or changing size (on the order of months), and the ability to be manufactured at a multiple kg/hr rate. In comparison, some other manufacturing methods of SNPs may suffer from a lack of scalability or require the use of potentially toxic solvents, making them less amenable to biological or environmental/agricultural applications. The amorphous nature of the starch nanoparticles also allows for functionalization to further chemically modify and/or crosslink the SNPs through surface functional group (i.e. hydroxyl) modification chemistries.

The optional functionalization of SNPs with hydrophobic groups (for example via grafting the starch with octenyl succinic acid (OSAn) or succinic anhydride (SAn)) as described herein produces a promising delivery system for agricultural applications. In some examples, hydrophobization increased the contact angle of a sprayed watermelon and pumpkin leaves from <60° (unmodified) to ˜80°. Confocal fluorescence microscopy confirmed that the hydrophobized SNPs can both adhere to the leaf surface as well as penetrate into the leaves. Without intending to be limited by theory, penetration into the leaves may be aided by the small size (10-50 nm) of the nanoparticles.

Three companies currently produce starch nanoparticles at an industrial scale: EcoSynthetix Inc. (EcoSphere™ technology), Mirexus (phytoglycogen technology), and NovaMont (Mater-Bi™ technology).

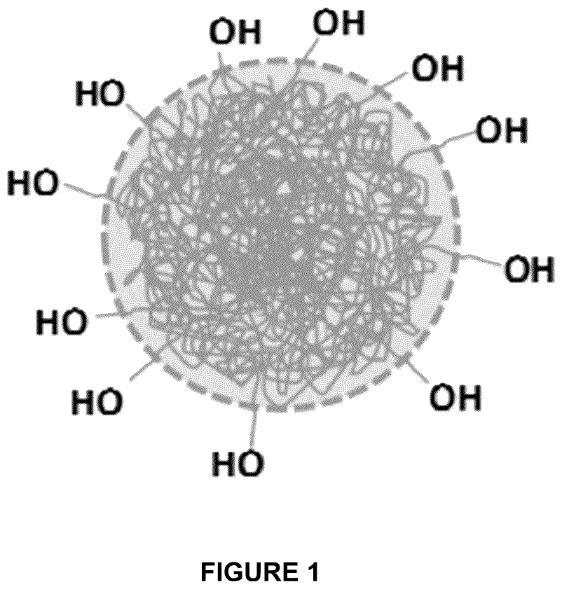

Aside from the previous attributions of low cost and availability, EcoSphere™ reactive extrusion technology is a particularly useful starting material for subsequent functionalization since: 1) it optionally results in SNPs with a very small specific size (20-50 nm, depending on the method of analysis used and the degree of nanoparticle hydration); 2) it is fully amorphous, enabling facile functional group chemistry and post-processing (unlike native starch that possesses a mixture of amorphous and crystalline (15-45%) domains, the latter of which interfere with water binding and thus the availability of hydroxyl groups for functionalization depending on their packing); 3) it may be enzymatically (α-amylase) or chemically (i.e. trifluoroacetic acid) degraded to make diverse structures; 4) it can be dispersed at much higher weight concentrations (˜35-40 wt %) than typical starch without huge spikes in viscosity; and 5) it has many possibilities for post-functionalization chemistry due to the presence of only one main functional group on the surface (—OH) as shown in FIG. 1.3.

The specific benefits of EcoSynthetix's SNPs may be related to the use of reactive extrusion for SNP manufacture. Reactive co-extrusion has been applied to chemically modify and process starch extensively in the past and is now being used by EcoSynthetix to create SNPs by using a plasticizer to help solubilize the starch granules entering the twin-screw extruder. When inside the mixing chamber, the particles experience high shear due to changing screw sizes/geometries, high pressure due to hydrostatic pressure, and high heat as controlled by the operator. This process helps mechanically break down the crystalline regions in the native starch granules and allow for gelatinization of the starch via cooling, optionally aided by the addition of crosslinkers depending on the application. By changing these parameters, the particle size, charge, and other important physiochemical properties can be modified, offering a highly scalable way to make functional SNPs.

Of note, while there is a considerable number of papers that discuss various ways of making starch-based particles or crystals, many of the properties of these materials may depend on the method used for processing and the source of the starch. In this specification, the experimental examples consistently use EcoSynthetix's commercial grade SNPs (e.g. EcoSphere™) to avoid variability issues and promote higher practical reproducibility of the materials (and thus application performance) achieved. However, other starch-based nanoparticles may be used.

Various examples involve the fabrication of hydrophobized SNPs via chemical modification with either succinic (SA) or octenyl succinic anhydride (OSA) to create SNPs with very different surfaces compared to their starting forms. Hydrophobization of the SNPs creates higher affinity delivery vehicles for hydrophobic bioactives in agriculture, or to allow for better attachment to plant leaf surfaces for foliar drug delivery. The native neutral surface charge and small size of the SNPs are demonstrated to enable modified SNPs to be highly effective but safe penetrants for plant-based bioactive delivery.

This specification describes a strategy to create nanoscale vehicles for the delivery of agricultural agents to plants. In some examples, some of the surface hydroxyl groups of the SNPs are replaced with hydrophobic moieties (octenyl succinic acid, OSAn and succinic anhydride, SAn) to make the surface of the SNP more hydrophobic. Such modifications promote physical crosslinking (i.e., hydrophobic interactions) between the SNPs while enhancing the adhesion of the SNPs to stick to naturally waxy leaves, for example of Arabsidopsis, pumpkin, and watermelon plants.

Agrochemicals such as herbicides, pesticides, fungicides, growth factors, or antimicrobials are most commonly delivered through the plant's leaves (foliar) or through the roots. While both routes have inherent limitations, the foliar delivery method is the most favourable from an industrial standpoint given that it allows for efficient large-scale application over large areas. However, with the foliar route, key challenges around the effects of animals/pests, rain, poor ab/adsorption due to the leaf's waxy cuticular protective barriers, and the variable size constraints associated with plant transport must be addressed to enable effective delivery. To address this challenge, we have modified SNPs with hydrophobic groups using octenyl succinic acid (OSAn) and succinic anhydride (SAn), aiming to enhance the retention of the SNPs on a leaf's surface as well as the ability of the SNPs to cross the waxy barrier and enter the cells. Hydrophobization increased the contact angle of a sprayed watermelon and pumpkin leaves from less than 600 (unmodified) to upwards of 80° when modified (DS 0.25), while confocal fluorescence microscopy confirmed that the hydrophobized SNPs can both adhere to the leaf surface as well as penetrate into the leaves when sprayed due to their small size (25-50 nm), offering the potential to translocate within plants due to the small size and net neural surface charge of SNPs. To demonstrate the potential of the highly mobile SNPs for payload delivery, SNPs were passively loaded with humic acid, achieving encapsulation efficiencies of >55% for all formulations and sustained release for >200 hours under simulated in vitro conditions. As such, the use of hydrophobized SNPs has significant potential benefits for treating plant diseases that require the transport of an agrochemical inside the leaf.

There is an increasing economic, environmental, and human health need to improve current agricultural practices to enhance the safety, bioavailability, and ultimately efficacy of pesticides, fungicides, herbicides, and plant growth promoters. The use of “green” chemistries has attracted particular interest in this regard, including the use of carbohydrate polymers such as starch for the design of bio-based drug/agrichemical carrier systems, soil conditioner/moisturizers, and other related products. More recently, hydrogel nanotechnologies have been proposed not only for their favorable physiochemical properties but also for their ability to allow engineers to facilitate new targeting strategies or delivery approaches.

In this context, the role of agricultural delivery vehicles to promote the transport of plant bioactives into plant tissues is of particular interest. A classical strategy to penetrate plant tissues is through the root system via capillary action of the root hairs and projections through the soil rhizome. However, soil-based delivery subjects formulations to multiple degradation stimuli including hydration, soil-based microbes, and other environmental factors like heat that can require more frequent re-application cycles. Delivery through the leaves while they are transpiring (foliar route) is also possible but also introduces additional challenges related to animals, rain effects, and poor ab/adsorption due to the waxy cuticular layer covering the apical sections of most leaves that act as a protective barrier against the entry of contaminants, with particularly notable size constraints observed for transport on both the cuticle and stromal sides of leaves. This latter factor of poor ab/adsorption is particularly limiting when spray-based aerosol formulations are used. Such formulations enable inexpensive administration of agrochemicals over large areas in a relatively short period of time; however, if a formulation is poorly retained by the leaves, potential issues with spray-based administrations including downstream human/animal exposure or the loss of agrochemical due to water evaporation, volatilization, or animal interactions become even more problematic.

The emerging use of nanotechnology in agriculture has in recent years facilitated re-engineering of the way in which agrochemicals interact with natural photosynthetic processes of plants. Nanoparticles (NPs) of various types including nano-capsules, micelles, liposomes, nano-emulsions, and dendrimers [486] have been explored as delivery vehicles for plant bioactives. Soft nanoparticles offer particular advantages in terms of their potential to exploit the viscoelastic properties of such materials to change their conformation (as demonstrated in other processes) and improve their potential to pass through small foliar and/or root-associated pores, significantly enhancing their potential to deliver bioactive agents into plants and subsequently transport across cell-cell junctions or cellular/nuclear membranes inside the plant tissue. Such transport properties are primarily dependent on the nanoparticle size and/or surface chemistry, although the potential of soft nanomaterials to deform to pass through smaller pores can also promote transport.

Root entry of nanoparticles may be by way of root tips, lateral roots, root hairs, rhizodermis or ruptures. Foliar entry may be by way of cuticle, stomata, hydathodes, lenticels or wounds. Entry by these means, and further transport in the plant, may be subject to size exclusion barriers. For example, entry into the stomata, hydathodes or lenticels of a leaf may be restricted to particles having a size of less than about 100 nm. Transport through the vasculature of a plant may also be limited to particles having a size of less tan about 100 nm.

An additional factor important for the uptake and more importantly translocation of nanoscale agrochemical delivery systems is the overall surface charge of the material. In general, the surface of most plant leaves bear a net negative charge, suggesting that cationic nanoparticles should result in enhanced surface retention following spray-based administration; however, the anionic cell membranes within the plant tissue can also bind to cationic nanoparticles and significantly reduce their mobility while enhancing off-site binding, depending on the plant type. Additionally, most soils are anionic due to their high concentrations of minerals and ions and can thus exhibit cationic exchange properties. The effects of surface charge on key processes in nanoparticle-assisted agricultural delivery such as translocation, transformation, uptake, and phytotoxicity have been extensively studied. Even though most prior studies describe the transport of hard metallic NPs rather than “soft” NPs, small surface-neutral nanoparticles appear to be most effective for mediating sufficient ab/adsorption and subsequent transport into leaves.

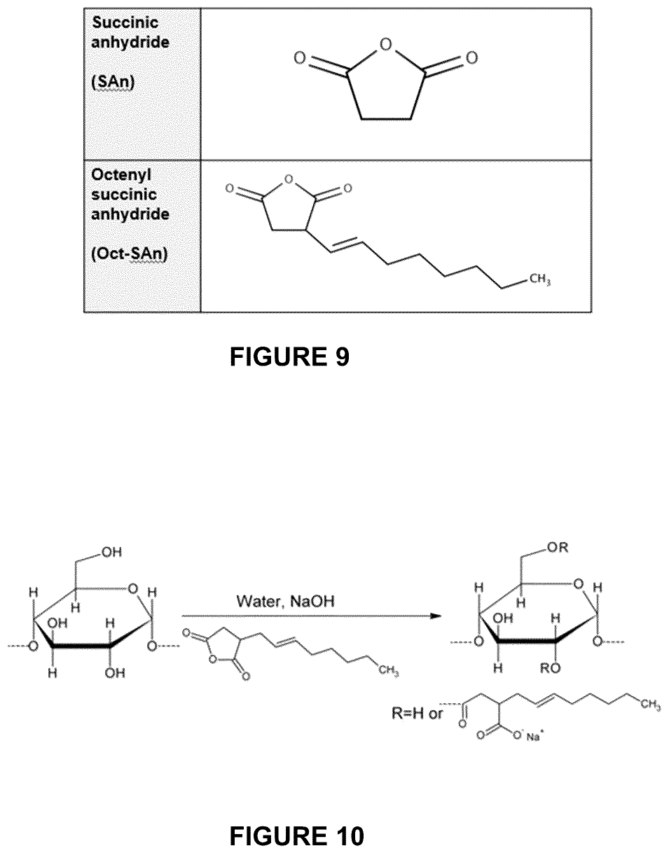

The starch nanoparticles described elsewhere in this thesis, with starting material produced on a commodity industry scale via a reactive extrusion process, are hypothesized to be small enough (25-50 nm) to pass through the leaf stomata (foliar) or root capillaries (soil) to penetrate into the plant as well internally throughout the plant through cell membranes and the extracellular spaces of cell walls. Additionally, the soft deformable gel-like nature of the SNPs coupled with their net neutral charge in water both offer the potential to improve nanoparticle transport across biological barriers, while the use of starch as the material is highly favorable in terms of preserving plant and environmental compatibility of the delivery vehicle. However, one potential drawback of the use of native SNPs for plant delivery is their highly hydrophilic (—OH-rich) interface, resulting in potentially poor ab/adsorption to leaves following spray-based administration. To address this potential drawback, herein we hydrophobize the SNPs using two anhydrides with varying hydrocarbon chain lengths: succinic anhydride (SAn) and octenyl succinic anhydride (OSAn), shown in FIG. 9, the latter of which is most noted for its use in food applications. Other hydrophobically modified starch nanoparticle systems created by grafting pyrene, imidazole, or cholesteryl groups have been reported; however, herein, we elected to use industrially relevant chemistry that is amenable with the reactive co-extrusion process used to create these SNPs to promote the potential scale-up of useful vehicle designs.

We hypothesize that these hydrophobized SNPs will (1) be able to penetrate into the leaves of plants when sprayed foliarly (size/charge effect); (2) be able to stick to the leaf surface following spray administration (hydrophobicity effect); (3) will translocate within the plants (size/charge effect); and (4) enable controlled release of a loaded cargo herein demonstrated using humic acid, a key soil component that aids in regulating internal plant cell metabolism and related photo-transformation processes and boosting growth patterns (hydrophobicity/internal particle morphology effect). Together, these properties are expected to enable effective transport of a targeted agrochemical into a plant and provide release of that agrochemical over a prolonged period to reduce the required frequency of bioactive agent administrations and thus the burden and cost of such administration to farmers.

### Experimental Examples

### Materials

Commercial grade starch nanoparticles (SNP) and cold water soluble starch controls were donated by EcoSynthetix Inc. Succinic anhydride (SAn), octenyl succinic anhydride (OSAn), sodium carbonate, fluorescein isothiocyanate isomer I (FITC), dimethyl sulfoxide (DMSO, reagent grade), and humic acid (HA, MW 2000-5 million g/mol) were all obtained from Sigma Aldrich (Oakville, ON) and used as received. The watermelon and pumpkin seeds were acquired from McKenzie Seeds (Brandon, MB). The Arabidopsis plants for testing SNP penetration via confocal microscopy was generously donated by Dr. Wenzi Ckurshumova. Milli-Q water (MQW) was used for all in vitro experiments. The 4″ plastic pots and Promix BX soil were both graciously provided by the McMaster University Department of Biology's Greenhouse.

Functionalization of SNPs with Anhydrides

To create a library of hydrophobized SNPs, succinic anhydride (SAn) and octenyl succinic anhydride (OSAn) were grafted to SNPs at targeted 0.10 and 0.25 degrees of substitution (DS) by modifying a previously reported protocol for SNP methacrylation (see FIG. 10). For each modification, 50 g of dry starch (54.3 g of the SNP stock, accounting for 8-10% hygroscopic water absorption as measured using microwave-assisted gravimetry at ambient lab conditions) was dissolved in a 600 mL of a 50:50 MQW/DMSO mixture and manually agitated with a magnetic stirrer (500-1000 rpm) in a 1 L round bottom flask to ensure SNP dispersion. Following, 0.7 g sodium carbonate was added to create an alkaline environment, after which a pre-determined amount of OSAn or SAn was added to the flask. The amount of OSAn or SAn added depended on the degree of anhydride grafting targeted based on the code X-Y where X is the anhydride used and Y is the targeted degree of substitution (SAn-0.10-3.09 g SAn, 54.31 g SNP; SAn-0.25-7.72 g SAn, 54.29 g SNP; OSAn-0.10-6.49 g OSAn, 54.29 g SNP; and OSAn-0.25-16.22 g OSAn, 54.29 g SNP). The reaction vessel was allowed to stir at room temperature, maintaining the pH in the range 10<pH<11 or 8<pH<9 (depending on the protocol used) throughout the reaction period via the addition of 1 M NaOH. The reaction was stopped when no further pH changes were observed, typically 20-30 hours following anhydride addition depending on the targeted DS. The crude product was then neutralized using 1 M HCl, dialyzed (6×6 h cycles, 3.5 kDa MWCO, Spectrapor), and lyophilized for storage.

### Physicochemical Characterization of Hydrophobized SNPs

### Degree of Substitution (DS)

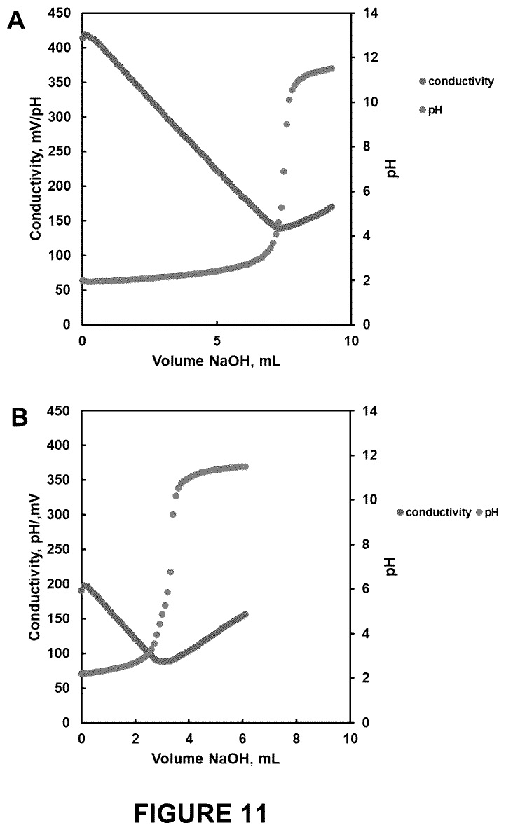

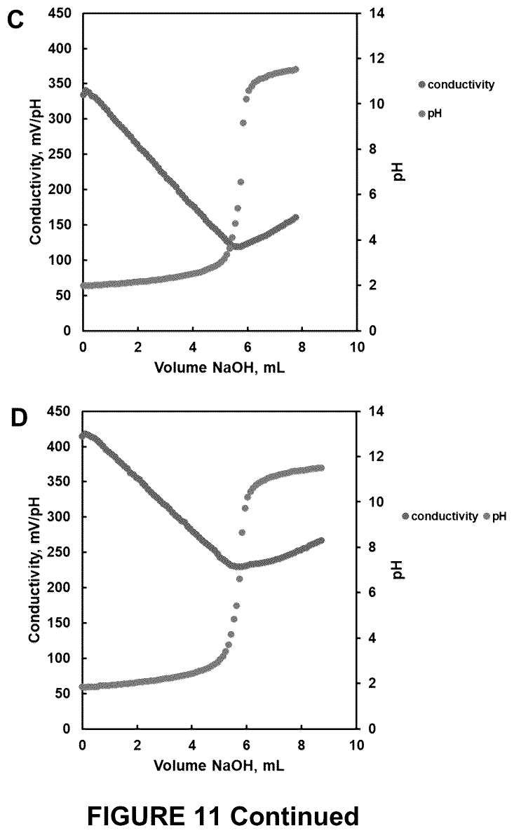

The experimental degree of substitution of the anhydride on SNPs was assessed via a base-into-acid conductometric titration (Mandel Model PC-1104-00 titrator with a Model 4510 conductivity meter), exploiting the fact that one carboxylic acid group is generated for every anhydride grafted to the SNP (FIG. 10). A mass of 50 mg of modified SNP was dispersed in a 50 mL solution of 3 mM KCl, the initial pH was lowered to ˜2 using 1 M HCl, and the sample was titrated with 0.1 M NaOH. By comparing the moles of acid detected to the moles of the anhydrous glucose unit (AGU) added, the experimental degree of substitution can be calculated. See FIG. 11 for the raw data used for the calculations.

### Particle Size Distribution and Electrophoretic Mobility

The particle size distribution of the SNPs was assessed before and after anhydride functionalization to assess whether the presence of the hydrophobic grafts altered the particle size or impacted SNP aggregation. A 1 w/w % suspension of each SNP in water was tested characterized using a Brookhaven Nano90Plus dynamic light scattering instrument. Each sample was placed in a 3510 Branson sonicating water bath on the lowest setting at room temperature (˜22°) for 5-10 minutes before analysis to ensure efficient SNP dissolution prior to measurement. A run consisted of ten individual measurements that are averaged, with two runs conducted for each sample/wt % combination. Intensity distributions were converted to number distributions using the refractive index of starch (1.34). To assess the electrophoretic mobility as a measurement of surface charge before and after chemical modification, a 1 wt % solution of SNPs was suspended in 5 mM NaCl (pH 7.1) and tested using the Nano90Plus instrument operating in phase analysis light scattering (PALS) mode.

### Surface Hydrophobicity

The imparted hydrophobicity resulting from the modification was confirmed using sessile drop contact angle measurements. Static contact angles were measured by the sessile drop method on glass microscope slides (Gold Line Microscope Slides, VWR). In a typical experiment, glass microscope sides were cleaned (Sparkleen detergent, Fisher Scientific), and a uniform section of watermelon and pumpkin plant leaves (cut with an Xacto blade into 1 mm×1 mm sections) were adhered to the slide using double-sided tape. Each functionalized SNP formulation was sprayed (10 times of waxy side and 10 times on non-waxy side) at a concentration of 5 wt % in MQW onto the leaf surface (attached to the microscope slide) before being adhered to the microscope slide. The treated slides were washed three times with a deionized water spray to remove unbound nanoparticles. The water/air contact angle was determined by placing a water drop on the dry slides. Contact angle measurements were performed using a Kruss contact angle measuring instrument running Drop Shape Analysis (DSA) 1.80.0.2 software. Two batches of gels were tested, as outlined in FIG. 14.

### Synthesis of Fluorescein-Labeled SNPs (FITC-SNPs)

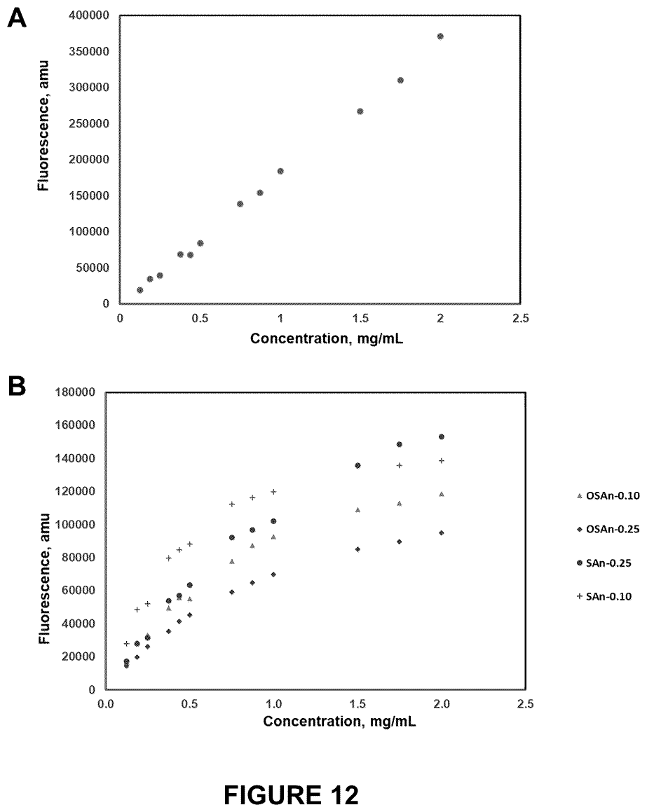

Native and hydrophobized starch nanoparticles were fluorescently tagged using an established protocol [369] by dissolving 50 mg of SNPs and 2 mg of FITC in a total volume of 100 mL of a sodium carbonate buffer (pH˜9.5). The mixture was stirred at room temperature overnight, after which the SNPs were dialyzed (3.5-5 kDa MWCO) and lyophilized to form the final purified product. A calibration curve relating fluorescence to SNP concentration was collected by suspending the FITC-SNPs in PBS at a concentration of 2 mg/mL, generating a set of serial dilutions, and analyzing the fluorescence using a PerkinElmer 1420 Multilabel counter Victor3V plate reader (λₑₓ=485 nm, λₑₘ=535 nm) (see FIG. 12).

### Photodegradation of FITC-SNP

To assess the potential photobleaching/photodegradation of the FITC-SNPs due to ultraviolet (UV) irradiation in natural or simulated growing conditions [509,510], FITC-SNPs were dispersed in MQW at a concentration of 5 wt % and irradiated in 20 mL scintillation vials under natural greenhouse conditions or simulated sunlight (HELIOS® Daylight Uniform Source System, Labsphere) with an irradiance of 1000 mM/m² s to track photodegradation for up to 3 days, a time point anticipated to be much longer than the rate of evaporation or transpiration of either plant [511,512]. The samples were manually agitated each day to prevent sedimentation and aggregation. Changes in fluorescence intensity were tracked to determine the extent of photo-bleaching or degradation using a plate reader as described above (λₑₓ=485 nm, λₑₘ=535 nm).

### Loading and Release of Humic Acid (HA)

To load humic acid into the SNP matrix, both passive diffusion and centrifugal loading were tested. For passive loading, the particles were soaked in a scintillation vial with 17 mL of 0.05 wt % HA solution (8.5 mg HA total per sample) at a concentration of 5 wt % SNPs for a total of 24 h to allow for diffusive loading into the porous and swellable particles. For centrifugal loading, a 5 wt % hydrophobized SNPs suspension in 17 mL of a 0.05% HA solution in MQW was centrifuged at 20,000 rpm for 15 minutes, with the concentration of (unloaded) HA in the supernatant measured via UV-vis spectroscopy (Cary 100) based on the difference in peak intensity at the wavelengths of 465 nm and 665 nm, following a previously published method [513]. The encapsulation efficiency (EE %) of HA into the SNPs (assuming all humic acid not present in the supernatant is loaded into the SNPs in the pellet) is calculated via Equation 5.1.

$$EE \% = \frac{Total [ HA ] - [ HA ] in Supernatant}{Total [ HA ]} = \frac{[ HA ] in SNPs}{Total [ HA ]} \qquad Eqn . 5.1$$

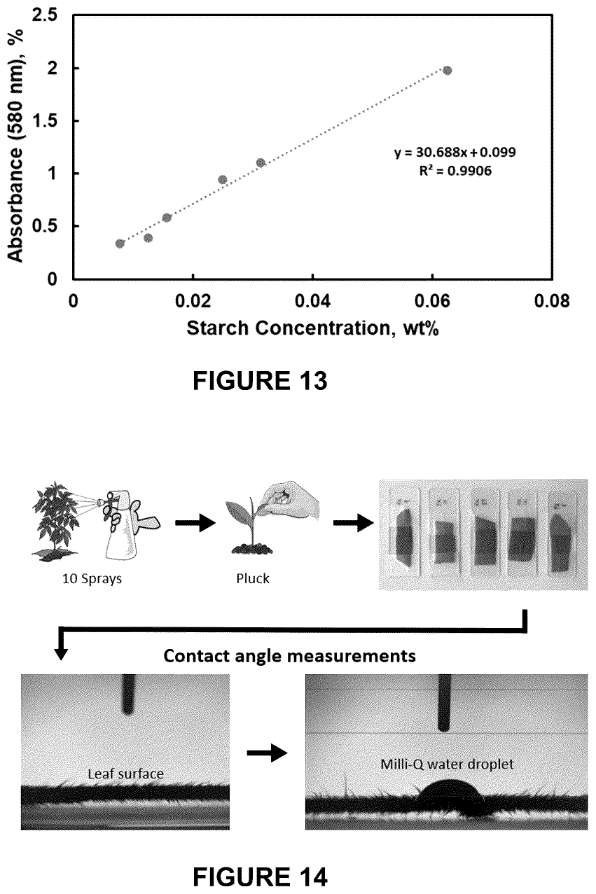

To assess the release kinetics of the loaded HA, Float-a-Lyzer experiments were conducted using low (3.5-5 kDa), medium (100 kDa), and high (1 million kDa) molecular weight cut-offs to enable an understanding of the relative release kinetics of different molecular weight fractions within the very broad 2000-500,000 g/mol cited molecular weight range of HA. HA-loaded SNPs were suspended into 0.1 M sodium pyrophosphate buffer and loaded into a 10 mL Float-a-Lyzer which is subsequently fully submerged in 17 mL of the same sodium pyrophosphate solution as the release medium. 2 mL samples were taken from the releasing medium and replaced with fresh buffer at each collection timepoint. Given the estimated weight-average molecular weight of SNPs of 250-500 kDa via gel permeation chromatography (GPC) [285], the 3.5-5 kDa membrane will track the release of low-MW HA, the 100 kDa membrane will enable tracking of primarily low/medium-MW HA release, and the 1 MDa membrane will allow passage of all HA fractions as well as the SNPs themselves. To confirm this latter point, iodine was used to determine the presence of starch in the release media by adding 50 μL of the 0.0125 M iodine stock solution to 3 mL of the unknown solution and tracking the colorimetric starch oxidation signal at 580 nm using UV-vis spectrophotometry [7], relating the colorimetric signal to the concentration of starch based on a starch-iodine calibration curve (FIG. 13).

### Plant Experiments

### Growth Conditions

All samples were grown in the McMaster University's greenhouse (latitude: 43.2580, longitude: −79.9180) and no additional growing agents or fertilizers were used. To each 4″ pot, ˜50 g of dry soil (Promix BX) was added, maintaining sufficient room to account for hydrogel swelling and natural moisture drainage. The watermelon and pumpkin seeds were planted during the summer months (May-August) ˜4 cm below the soil surface. The plants were watered every other day and allowed to grow for a total of four weeks (28 days) before conducting any spray tests to allow for the first leaf emergences to grow to maturity (true leaves). The plants were watered every other day until which point water is visibly draining from the bottom of each pot.

### Adhesion to the Leaf Surface

FITC-SNPs were dispersed in MQW at a concentration of 5 wt % and loaded into a standard 10 mL spray bottle. To each plant, 10 sprays were administered to the cuticle side (top) and the stomata side (bottom) of the leaves (20 sprays total) and left to sit in the greenhouse overnight to allow for the suspension to dry on the leaf surface. At t=24 h, the leaves were cut from the live plant with trimming scissors, immediately after which eight 0.5″ diameter circular cuts were made randomly in each leaf and placed in separate wells of a 48 well plate, four with the cuticle side up and four with the stomatal side up. Unsprayed leaves were also tested for background fluorescence, with the background subtracted from the measured fluorescence from the FITC-SNPs. Tests were performed using both Citrullus lanatus (watermelon) [514] and Cucurbita pepo (small sugar pumpkin) [515], both of which have larger stomata of sizes 5-8 μm.

Penetration into Plant Leaves

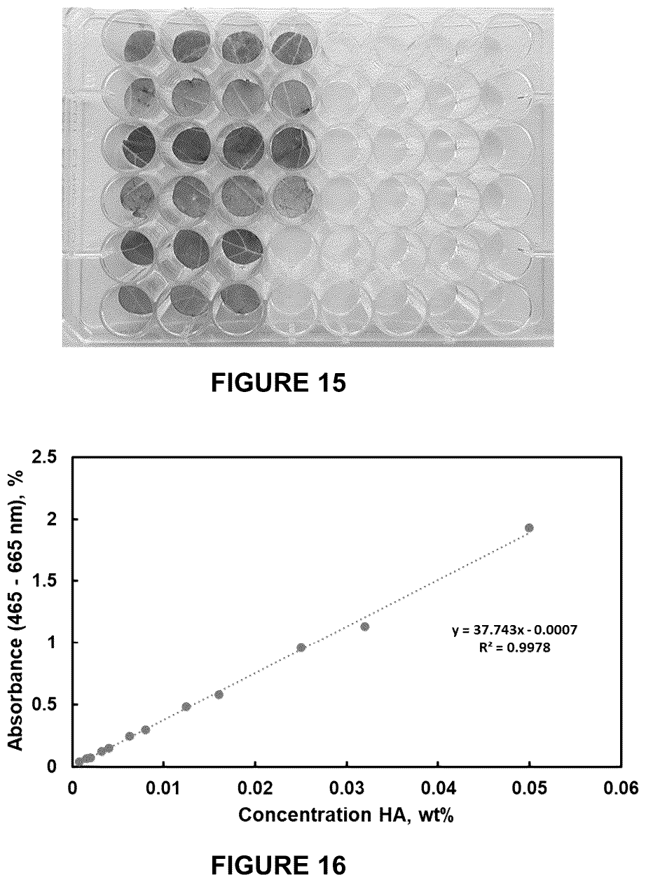

Leaves were sprayed with selected formulations in the same manner as previously described (20 sprays, 10 each side) and dried for 24 h. Following, randomly located sections were carefully extracted for the root hairs, stem (at various points), and leaves and placed into glass-bottomed 48 well plates for visualization (FIG. 15). The samples were imaged using confocal microscopy (Nikon Eclipse Ti) to determine the extent of penetration/uptake into the different plant tissues using the GFP/FITC (480/30 excitation filter) and the TRITC/Cy3 (540/25 excitation filter) long pass filter cubes. For the initial penetration tests using pumpkin and watermelon plants, only the FITC filter was used; for the Arabidopsis penetration test, both filters were used since the TRITC filter can show the choloroplasts and cellular material without significant photobleaching of FITC-SNPs.

### Results and Discussion

### Starch Nanoparticle (SNP) Characterization

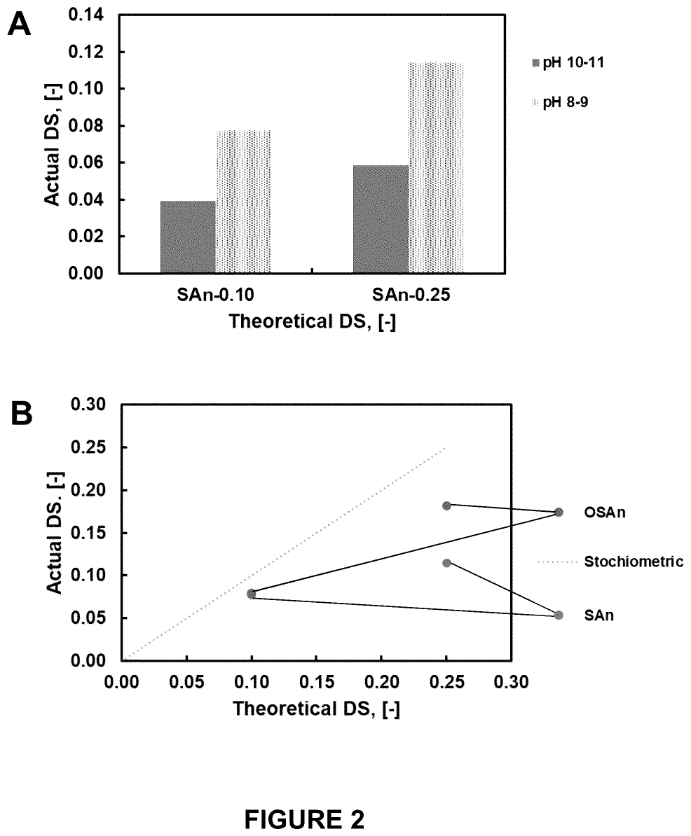

Succinic anhydride (SAn) and octenyl succinic (OSAn) were grafted to SNPs to enhance the hydrophobicity of the SNPs, hypothesized to improve SNP adhesion to plants upon spray-based application. FIG. 2 panel A shows the comparison between the experimental degree of substitution (DS) value and the pH at which the reaction is run, as measured via conductometric titration of the residual carboxylic acid group that forms upon anhydride grafting. Performing the grafting reaction at pH 8-9 led to higher experimental DS values for both SAn and OSAn modification compared to when the grafting reaction was conducted at pH 10-11. This result is hypothesized to relate to the increased ionic strength of the suspension at higher pH values partially collapsing the nanogel-like SNPs and making the internal hydroxyl groups less accessible for anhydride grafting; pH 8-9 was thus used for all further modifications. FIG. 2 panel B shows a comparison between the theoretical (x-axis) and actual (y-axis) DS values, with stoichiometric grafting indicated by the green line. Both SAn and OSAn grafting achieves ˜80% of theoretical substitution at a theoretical DS of 0.10; at the theoretical DS of 0.25, the OSAn modification maintained relatively high grafting efficiency (73% of theoretical) while the SAn grafting is less efficient (46% of theoretical). It is postulated that the lower functionalization efficiency observed with succinic anhydride-modified particles compared to octenyl succinic anhydride-modified SNPs may be due to competing hydrolysis reactions occurring during the strong base into acid titration, with the smaller molecule (SAn) hydrolyzing faster to reduce graft yields; hydrophobic interactions between unbound octenyl succinic anhydride and bound octenyl succinic acid groups on the SNP surface may also drive the recruitment of unbound hydrophobic groups to the particle surface to promote more effective grafting. However, the results indicate that both SAn and OSAn can effectively functionalize SNPs with hydrophobic grafts, exploiting the (unusually) high chemical reactivity of the starch —OH groups in the reactive extrusion-processed SNPs.

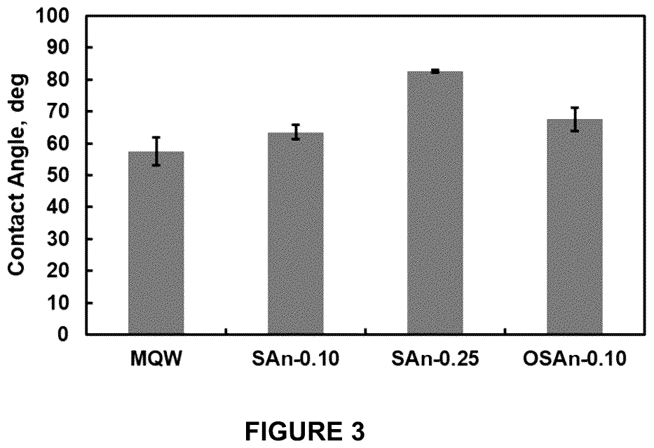

To assess the change in hydrophobicity induced by anhydride grafting, the hydrophobized SNPs were sprayed on a leaf surface and the contact angle was measured (FIG. 3). With the succinic anhydride modified starch nanoparticles, a notable increase in contact angle (CA) from 63.5° to 82.5° was observed when the DS was increased from 0.10 to 0.25, consistent with the introduction of more alkyl groups to the SNP. In comparison, the same treatment performed on the leaf controls by spraying MQW alone resulted in a contact angle of 57.4°, indicating that even the lowest DS/least hydrophobically modified starch (SAn-0.10) was effective at enhancing the hydrophobicity of the SNPs. In comparison, using OSAn-modified starch resulted in even larger enhancements in contact angle at equivalent DS values (i.e. comparing SAn-0.10 and OSAn-0.10), as anticipated based on the longer alkyl chain present in this formulation. As such, the anhydride grafting strategy significantly enhances the hydrophobicity of the SNPs.

The particle size of the anhydride functionalized SNPs was measured by dynamic light scattering (DLS). Hydrophobization of the SNPs results in an increase in interparticle interactions, leading to higher particle sizes by intensity (which especially weights the presence of larger aggregates in calculating the overall particle size). This size increase is particularly notable at higher SNP concentrations since particle-particle interactions are more likely to occur. SNPs functionalized with more anhydride (i.e. higher DS values) and/or the anhydrides with longer alkyl chains (i.e. OSAn instead of SAn) resulted in reduced colloidal stability at these SNP concentrations in aqueous suspension, consistent with increasing interfacial hydrophobicity that reduces the steric stabilization that leads to SNP dispersion in polar solvents. Of note, when comparing DMSO and MQW results, DMSO can much better disperse the hydrophobized SNPs, justifying use of the 50:50 DMSO:MQW mixture used during synthesis to enable pH control but also reduce overall polarity in the system and thus the aggregation/swellability of the particles in solution. The DLS data reported herein used a refractive index of 1.34 (for starch) to convert the intensity averaged data (which is independent of the particle refractive indices) to the number averaged data. However, the trends in the data will remain the same irrespective of the refractive index used for processing.

Table 1 shows dynamic light scattering (DLS) results for 0.5 wt % anhydride-functionalized and unmodified SNPs reported in terms of intensity averages or number averages. Results are given for dispersions in DMSO (left) and Milli Q water (right) with the standard deviations given.

TABLE 1

| | DMSO | | 5 mM KCl | | |
|---|---|---|---|---|---|
| | Avg. | Avg. | Avg. | Avg. | |
| | Diam. | Diam. | Diam | Diam | |
| | (intensity), | (number), | (intensity), | (number), | Mobility, |
| Sample | nm | nm | nm | nm | (μ/s)/(V/cm) |
| SAn-0.25 | 465 ± 162 | 20 ± 1 | 975 ± 126 | 21 ± 1 | −1.31 ± 0.09 |
| SAn-0.10 | 236 ± 28 | 15 ± 3 | 338 ± 32 | 18 ± 6 | −0.64 ± 0.04 |
| OSAn-0.25 | 498 ± 104 | 17 ± 9 | 978 ± 259 | 12 ± 3 | −1.67 ± 0.07 |
| OSAn-0.10 | 267 ± 150 | 11 ± 6 | 430 ± 159 | 23 ± 6 | −1.10 ± 0.14 |
| Unmodified SNP | 194 ± 8 | 19 ± 6 | 237 ± 12 | 21 ± 8 | 0.03 ± 0.15 |

The extent of differences in charge between the unmodified and hydrophobized SNPs was assessed by measuring the electrophoretic mobility measurements. In general, the hydrophobized SNPs exhibited a more negative charge than the unfunctionalized SNPs, consistent with the generation of a residual —COOH group on the SNP for every SAn or OSAn grafted to the SNP; however, the magnitude of the measured electrophoretic mobilities suggest that even the modified SNPs are only weakly anionic (<2 (μ/s)/(V/cm)) and are not expected to induce large charge-charge repulsion on the naturally anionic plant membrane surfaces. Coupled with the maintained small size of the modified SNPs these results suggest that SNPs may have desirable properties for functional delivery of the nanoparticles to plants.

It is important to note the significantly lower number average particle size measured for OSAn-0.25 compared to OSAn-0.10. We hypothesize that the significantly higher concentration of alkyl chains attached to the surface OSAn-0.25 induces significantly stronger hydrophobic interactions that induce dewatering of the nanogel-like SNPs, resulting in the overall number average diameter of the SNP decreasing from 23±6 nm by number in 5 mM KCl (OSAn-0.10) to 12±3 nm by number in 5 mM KCl (OSAn-0.25); in comparison, the much less hydrophobic SAn grafts do not add sufficient hydrophobicity to drive such deswelling at the same DS values of 0.10 (18±6 nm) and 0.25 (21±1 nm).

### Photodegradation Testing

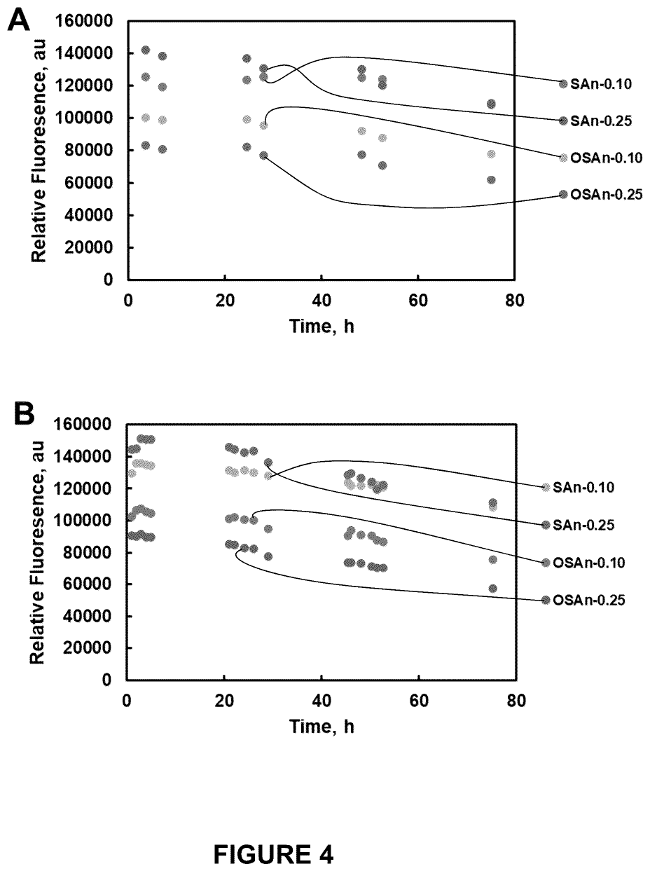

Prior to using fluorescein-labeled SNPs (FITC-SNPs) for probing the adhesion and penetrability of the hydrophobized SNPs in plants, the photodegradation of FITC-SNPs was assessed to ensure the fluorescence signal from the SNP was maintained following exposure to typical sunlight/simulated sunlight light wavelengths. Scintillation vials of the FITC-tagged hydrophobized SNPs were left in both natural greenhouse conditions (FIG. 4, panel A) and simulated sunlight on the bench in the lab (FIG. 4, panel B), with the trends in relative fluorescence intensity over time shown in the figures.

By comparing the general trends in photodegradation in FIG. 4, panel A (greenhouse) to that of FIG. 4, panel B (Helios), the relative rates of degradation are comparable under both growth conditions; while all samples did see a decrease in fluorescent signal over the course of the ˜80 hour experiment in both the greenhouse (13-26% decrease) and under simulated light (16-36% decrease), the decreases were relatively modest and the residual fluorescence would still allow for facile tracking of nanoparticle distribution on a timescale relevant to the growth schedules of the plants selected for screening [516]. Given the results presented herein, it appears as if photodegradation is not a major concern given the time frame of the release studies that will be performed acutely (2 weeks or less).

### Humic Acid Encapsulation & Release

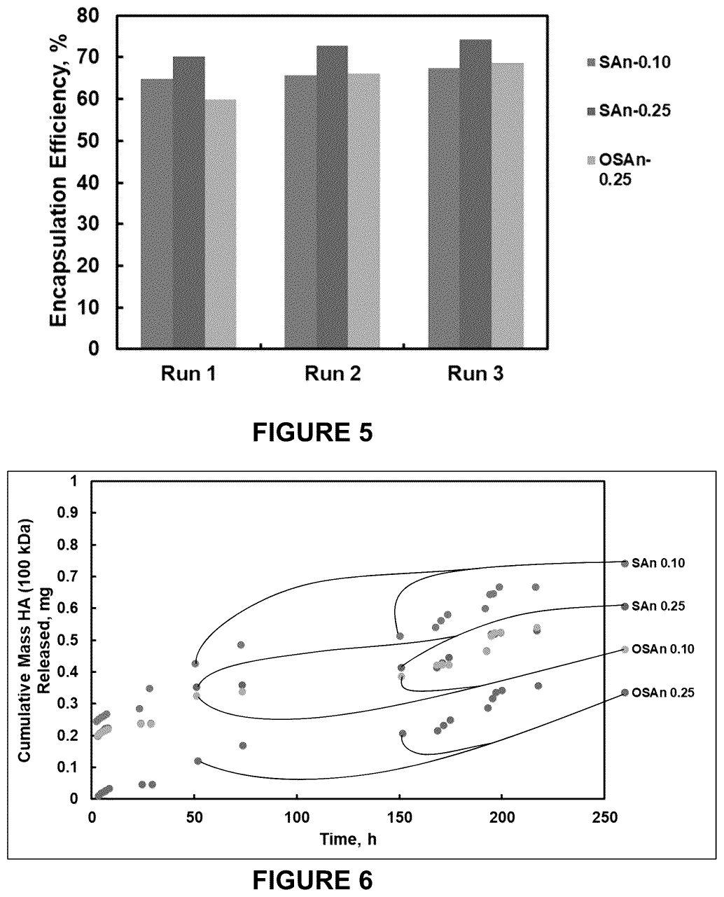

To assess the potential of the hydrophobized SNPs to enhance the delivery of bioactive agents to plants, humic acid (HA) was selected as the model bioactive given its key biological roles in plant growth and attractive combination of water solubility and highly aromatic internal structure (exploiting both the swellability of SNPs and the hydrophobic domains in the hydrophobized SNPs to enhance HA loading and control subsequent HA release) [508,517]. HA was loaded into SNPs via passive diffusion (as is commonly used to load hydrated nanoparticles with bioactives) and centrifugal loading strategies. High HA loadings corresponding to 60-70% encapsulation were achieved via centrifugal loading (FIG. 5), a result attributed to the role of the hydrophobic grafts in enhancing physical interactions between HA and the SNPs. Given that the centrifugal method is both faster and more effective than the lengthy passive diffusion method, centrifugal loading was used for all future tests. Of note, when HA was centrifuged alone in the absence of SNPs, no pellet whatsoever was formed; as such, we expect that all the HA that co-localizes with the SNP pellet is loaded into (or on the surface of) the SNPs and not simply precipitated by the centrifugation process. For each sample, three centrifuge runs at the speeds and times indicated previously were performed and the % EE was calculated after each to determine if longer centrifugation spinning would further improve loading. Note that, due to the very high specific surface area of SNPs and the very broad molecular weight distribution of HA, this high EE value could correspond to the uptake of HA inside of SNPs or the adsorption of HA to the SNP surface, either of which can enable efficient HA delivery.

The release kinetics of the loaded HA from the hydrophobized SNPs are shown in FIG. 6. Given the broad molecular weight distribution of the loaded HA, release was tracked using a 100 kDa dialysis membrane based on the large MWD of humic acid. A very small amount of HA was released in the first 350 h (<1 mg), likely due to hydrophobic interactions that could occur with the cellulose ester membranes of the Float-a-Lyzers or due to strong interactions between the HA and the SNPs. The latter hypothesis is supported by the observation that SNPs prepared with lower DS values and/or shorter hydrophobes (i.e. SAn instead of OSAn) release more drug faster, with the most hydrophobized SNP (OSAn-0.25) being particularly efficient at reducing burst HA release given its more condensed state. As such, hydrophobized SNPs can both enhance the loading and prolong the release of HA. It is anticipated similar benefits would be exhibited with other low solubility and/or amphiphilic bioactives that would benefit from the amphiphilic internal structure of the hydrophobized SNPs.

### Plant Experiments

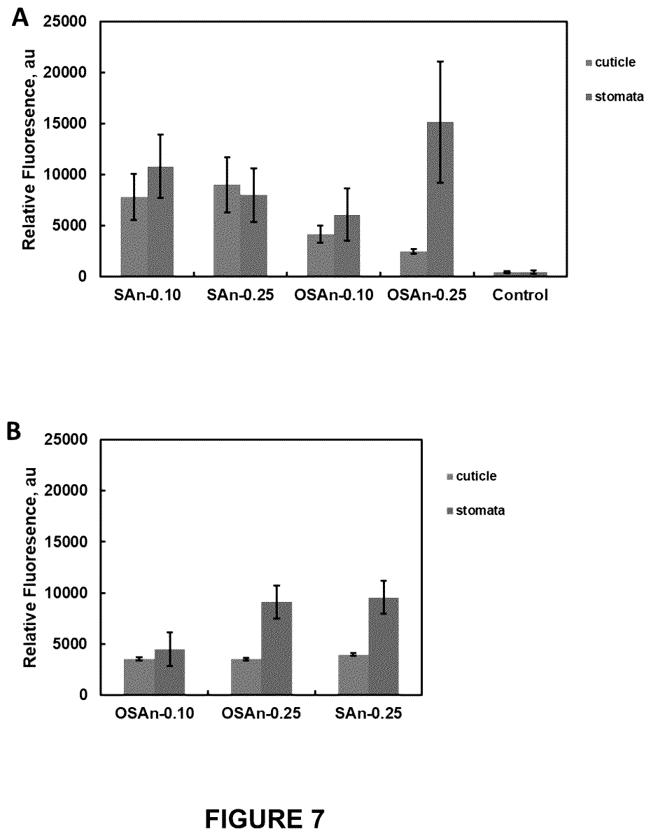

Suspensions of (unloaded) FITC-SNPs were sprayed on both the stomal and cuticular sides of pumpkin and watermelon leaves followed by fluorescence microscopy analysis of SNP retention on the leaf using a plate reader (see FIG. 15 for a picture of a representative experiment). Representative results for SNP retention are shown in FIG. 7 panel A (for pumpkin leaves) and FIG. 7, panel B (for watermelon leaves). In general, stomatal side retention was significantly higher than cuticular retention, consistent with the presence of the waxy barrier on the cuticular side as well as the known role of the stomata in promoting particle transport into leaves. While the DS did not significantly alter the apparent retention of the SNPs in SAn-functionalized SNPs, the higher DS OSAn-functionalized SNPs retained significantly better on the stomatal side in both pumpkin and watermelon leaves. This result is consistent with the higher interfacial hydrophobicity of OSAn-0.25 enhancing the interfacial interaction with the waxy barrier on the leaf.

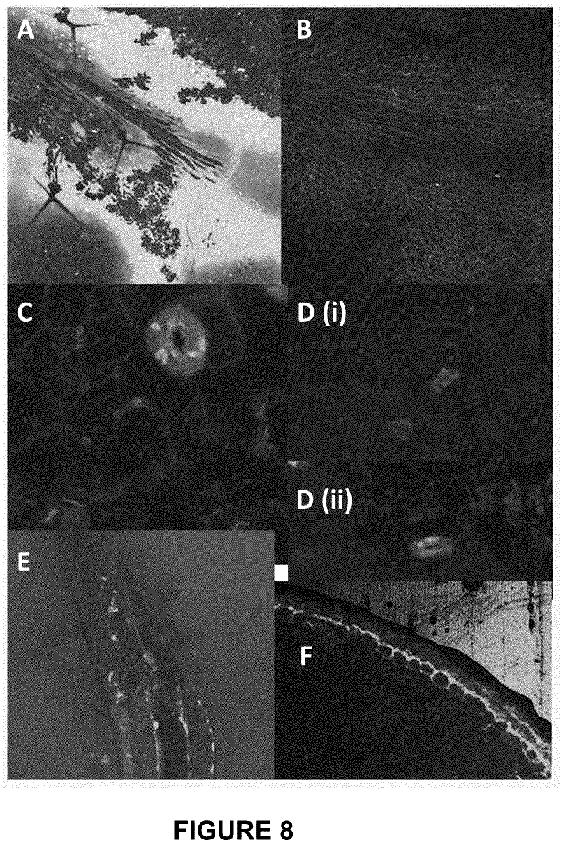

To get a better assessment of the potential for hydrophobized SNPs to penetrate and even translocate within plant tissues, Arabidopsis was selected as the plant model given that it has the highest average number of stomata per square mm of tissue and its stomata is the largest in diameter among common crops (30-60 μm); both these factors can promote improved nanoparticle transport. Furthermore, relative to pumpkin and watermelon leaves, Arabidopsis leaves are thinner and easier to image the underlying plant tissue for better contrast and better assessments of penetration deeper into the leaf. Based on OSAn-0.25 exhibiting both the highest retention on both watermelon and pumpkin leaves (FIG. 7) and the smallest size (and thus the hypothesized highest transport potential, Table 1), FITC-OSAn-0.25 was probed for its translocation potential using confocal microscopy; note that in this case the plant cells are also visible (in red) due to imaging also being conducted using the TRITC filter in which the autofluorescence of the chloroplasts can be visualized independently of the FITC-labeled hydrophobized SNPs. FIG. 8, panel A shows a strong retention of the SNPs immediately after they are sprayed on the surface of an Arabidopsis leaf, confirming their high retention in a third plant model with different properties from the hairy pumpkin and watermelon plants. Following washing of the surface three times with water (FIG. 8, panel B), much of the green color disappears as weakly adsorbed particles are washed away; however, there is clear evidence of SNPs persisting in the intercellular gaps between the cells, indicating successful penetration of the SNPs into the leaf. SNPs are also clearly visible in the stomata of the leaves as indicated by the green O-ring visible in FIG. 8, panels C and D, suggesting that SNPs can both transport through the micrometer stomatal openings as well as penetrate cellular gaps once there. Of note, to our knowledge, no other bio-based nanoparticles have previously been reported to not only adhere to plant surfaces and penetrate through cellular junctions but also penetrate into the stomata and related membranes when sprayed foliarly, a combination of properties that would facilitate the protection and active transport of agrochemicals from the point of administration into the body of the leaf. The most hydrophobic and smallest number average diameter (Table 1) FITC-OSAn-0.25 SNPs can also penetrate through the root cells, with FIG. 8 panel E showing clear evidence of the SNPs transporting up and down the length of a root and FIG. 8 panel F suggesting that the SNPs could penetrate the first few epithelial layers of the root. Without intending to be limited by theory, we attribute this result to hydrophobic interactions with the hairy roots that are rich in secreted mucilage both dry and wet.

The hydrophobized SNPs offer several biological benefits for penetration into and through plants. First, the outside surface of leaves are rich in waxes and lipids that help promote water droplet roll-off so the leaf cells can remain isotonic. The natural microscopic ridges and roughness of plant leaves also help to mechanically trap applied nanoparticles, with hydrophobized nanoparticles more likely to adhere given the leaf surface chemistry. Once the SNP has penetrated a leaf, the fluid mosaic model of plants suggests that the hydrophobic surface also helps promote translocation throughout the plant since the native plant cell membranes are lipid-rich and charge sensitive (making the near-neutral charge of the hydrophobized SNPs beneficial for promoting intra-leaf transport). As such, the hydrophobized SNPs offer clear translational benefits for both foliar and root-based agrochemical delivery in terms of increasing the penetration of bioactives into plants via multiple transport routes.

### CONCLUSIONS

Hydrophobized starch nanoparticles are promising vehicles for foliar or soil-based agrichemical delivery given their favorable size, deformabililty, and charge for promoting both leaf adhesion and subsequent translocation into plants. Hydrophobization of the commercial SNPs via grafting of succinic anhydride (SAn) or octenyl succinic anhydride (OSAn) at two degrees of substitution (DS=0.10 and 0.25) was demonstrated to increase the contact angle and, by extension, enhance adhesion of the SNPs on the surfaces of both pumpkin (Cucurbita pepo) and watermelon (Citrullus lanatus) leaves. Humic acid uptake and delivery is enabled by the amphiphilic internal structure of the hydrophobized SNPs. Preliminary penetration tests suggest that FITC-tagged hydrophobic SNPs are not detectable in the stems or roots 24 h post spraying but can be seen in the leaf vasculature. A further test with the Arabsidopsis plant suggests that the most hydrophobized SNP can effectively penetrate into the leaf, into the stomata, and through the root hairs of the plants. Coupled with the fact that SNPs are made from a sustainable source (corn) and can be fabricated on large industrial scales (via reactive co-extrusion), the use of hydrophobized SNPs as a sprayable delivery vehicle for large-scale agricultural applications offers a renewable and functional option for functional agrochemical delivery.

In some examples, anhydride chemistry is used to create hydrophobized SNPs using succinic (SAn) and octenyl succinic (OSAn) anhydride grafting targeting varying degrees of substitution (DS=0.10 and 0.25). The particles were fluorescently tagged with FITC isomer I and sprayed onto the surface of pumpkin leaves to assess the potential of the hydrophobized SNPs for leaf adhesion (via a plate reader) and penetration potential into a leaf (via confocal microscopy). Significant improvements in both pumpkin and watermelon leaf adhesion and Arabidopsis penetration (the latter in particular a key challenge with nanoparticle-based agrochemicals) were observed using hydrophobized SNPs. The particles could also be loaded with humic acid (HA), one of the primary components of soil that helps regulate internal plant cell metabolism and related photo transformation processes and help boost growth patterns as a biostimulant; in vitro release was observed over the course of at least 13 days. The SNPs may be introduced at either the stomata (leaf surface) or root capillaries.

The hydrophobized SNPs amy be used to deliver other types of bioactives. Hydrophobic agrochemicals can be selected for delivery to exploit drug-NP hydrophobic interactions for enabling better loading while preserving the softness and external hydrophilicity of starch nanoparticles. Alternately, phosphinothricin can be loaded for use as an antimicrobial. The further addition of plant-adhesive functional groups/ligands and waxy cuticle dissolvers would could be implemented to improve the release and translocation even more to further broaden the application of SNPs in agriculture.

The following is a list of terminology, symbols, and abbreviations used herein:
GRAS; “generally regarded as safe”
NP; nanoparticle
STPP; sodium polyphosphate
STMP; sodium trimetaphosphate
AGU; anhydrous glucose unit
CA; contact angle
DLS; dynamic light scattering
DMSO; dimethyl sulfoxide
DS; degree of substitution
FITC; fluorescein isothiocyanate isomer I
GPC; gel permeation chromatorgraphy
HA; humic acid
MQW; Mili-Q water
MW; molecular weight
MWCO; molecular weight cut off
OSAn; octenyl succinic anhydride
PBS; phosphate buffered saline
SAn; succinic anhydride
SNP; starch nanoparticle
UV; ultraviolet

Design & Fabrication of Nanostructured Hydrogels from Biopolymer Nanoparticle Building Blocks for Biomedical and Environmental Applications, a Ph.D. these submitted by Michael J. Majcher to the McMaster University department of Chemical Engineering, is incorporated herein by reference.

We claim:

1. A nanoparticle comprising,
starch; and,
an agricultural active agent.

2. The nanoparticle of claim 1 comprising hydrophobic groups.

3. The nanoparticle of claim 1 having a size in the range of 10-50 nm.

4. The nanoparticle of claim 1 wherein the starch is grafted with octenyl succinic acid and/or succinic anhydride.

5. A method of making a nanoparticle comprising,
providing a starch-based nanoparticle; and,
combining an agricultural active agent with the starch.

6. The method of claim 5 comprising functionalizing the starch with hydrophobic groups.

7. The method of claim 6 comprising reacting the starch with octenyl succinic acid and/or succinic anhydride.

8. A method of treating a plant comprising applying starch-based nanoparticles combined with an agricultural active agent according to the plant.

9. The method of claim 8 wherein the nanoparticles are applied in a foliar spray.

10. The method of claim 8 wherein the nanoparticles are hydrophobic.

11. The method of claim 8 wherein the nanoparticles have a size in the range of 10-50 nm.
